(19) United States
(12) Patent Application Publication
(10) Pub. No.: US 2025/0266452 A1
(43) Pub. Date: Aug. 21, 2025

(54) DRY NEGATIVE ELECTRODE FOR LITHIUM SECONDARY BATTERY AND A METHOD OF MANFACTURING SAME

(71) Applicants: Hyundai Motor Company, Seoul (KR); Kia Corporation, Seoul (KR); SEOUL NATIONAL UNIVERSITY R&DB FOUNDATION, Seoul (KR)

(72) Inventors: Yong Il Cho, Seoul (KR); Han Nah Song, Suwon (KR); Hyun Jin Kim, Daegu (KR); Chan Bum Park, Suwon (KR); Hyeon Ha Lee, Anyang (KR); Young Soo Lee, Yongin (KR); Jang Wook Choi, Seoul (KR); Tae Geun Lee, Ansan (KR); Ji Woo An, Seoul (KR)

(21) Appl. No.: 18/889,533

(22) Filed: Sep. 19, 2024

(30) Foreign Application Priority Data
Feb. 16, 2024 (KR) 10-2024-0022422

(51) Int. Cl. H01M 4/583; H01M 4/02; H01M 4/04; H01M 4/1393; H01M 4/62; H01M 10/052

(52) U.S. Cl. CPC H01M 4/583; H01M 4/04; H01M 4/1393; H01M 4/623; H01M 4/625; H01M 10/052; H01M 2004/027

(57) ABSTRACT

Provided is a negative electrode for a lithium secondary battery, comprising a negative electrode active material and a fibrous binder. The negative electrode active material has an ID/IG value of about 0.18 or more and less than about 0.7 as a result of Raman spectroscopy analysis. The active material may be carbon-based and exhibit specific characteristics according to X-ray diffraction (XRD) analysis. The fibrous binder may be polytetrafluoroethylene (PTFE). Additionally, a method of manufacturing the negative electrode involves preparing a mixture of the active material and a binder precursor, then fiberizing the binder precursor by applying shear stress. The negative electrode may also include a conductive material. The disclosure further includes a lithium secondary battery comprising this negative electrode.

### CROSS REFERENCE TO RELATED APPLICATION

The present application claims under 35 U.S.C. § 119 (a) the benefit of Korean Patent Application No. 10-2024-0022422, filed Feb. 16, 2024, the entire contents of which is incorporated herein for all purposes by this reference.

### BACKGROUND

### Technical Field

The present disclosure relates to the field of lithium secondary batteries, specifically to the development and application of negative electrodes. It focuses on negative electrode materials and compositions that enhance battery performance, including the use of carbon-based active materials, fibrous binders such as polytetrafluoroethylene (PTFE), and conductive additives. The disclosure also covers methods for manufacturing these negative electrodes, aiming to improve the electrochemical stability, conductivity, and overall efficiency of lithium secondary batteries.

### Background

Elements that make up the electrode of a lithium secondary battery include active materials, conductive materials, and binders. The active materials determine the capacity of the lithium secondary battery. The conductive materials contribute to improving electronic conductivity. The binders stabilize the electrode by allowing the components to adhere well to each other. Various polymers are used as binders for an electrode corresponding to their characteristics. During the charging and discharging process of a lithium secondary battery, the binders may receive electrons and be decomposed due to an electrochemical reaction, causing the binders to lose their function. It is necessary to manufacture electrode components in a single slurry form, as well as to use and dry solvents to increase dispersibility.

It is necessary to thicken an electrode to improve energy density, but an electrode coating technology based on the existing wet process has limitations in improving the thickness of the electrode. Furthermore, since solvents are used to make slurries, a drying process for solvent recovery is essential. Meanwhile, a dry process allows a thick electrode to be easily formed and solvents not to be used. So far, polytetrafluoroethylene (PTFE) is the only binder that can be processed in a dry process. Still, polytetrafluoroethylene (PTFE) undergoes an electrochemical decomposition reaction at a voltage of around 0.5 V (vs Li/Li⁺). The reason is that polytetrafluoroethylene (PTFE) has a molecular structure in which a large amount of fluorine is attached to carbon atoms. This is believed to be the cause of instability.

### SUMMARY OF THE DISCLOSURE

The present disclosure is to provide a negative electrode for a lithium secondary battery that alleviates the decomposition reaction of polytetrafluoroethylene (PTFE) and a method of manufacturing the same.

The present disclosure is not limited to the purpose mentioned above. The purpose of the present disclosure will become clearer from the following description and may be achieved by means and combinations thereof as set forth in the claims.

In some embodiments, a negative electrode for a lithium secondary battery comprises a negative electrode active material and a fibrous binder, where the negative electrode active material has an ID/IG value of about 0.18 or more and less than about 0.7 as a result of Raman spectroscopy analysis. The negative electrode active material may be a carbon-based material. The active material may exhibit an XRD peak corresponding to the (002) plane at about 26.5°±0.5° according to X-ray diffraction (XRD) analysis results. An XRD peak corresponding to the (002) plane of the negative electrode active material may have a full width at half maximum (FWHM) of about 0.3 or more and less than about 0.395 according to XRD analysis results.

The fibrous binder may comprise a variety of materials including organic and inorganic fibers, such as glass fibers, carbon fibers, substituted carbon fibers such as halogenated including fluorinated carbon fibers. graphite fibers, etc. The thickness of the fibers is not particularly limited and in certain embodiments may be e.g 3 to 30 μm, or 5 to 20 or 30 μm. In certain preferred aspects, the fibrous binder may comprise polytetrafluoroethylene (PTFE).

The negative electrode may comprise about 50% by weight to about 99.9% by weight of the negative electrode active material and about 0.1% by weight to about 50% by weight of the fibrous binder.

In some embodiments, a method of manufacturing a negative electrode for a lithium secondary battery comprises preparing a mixture comprising a negative electrode active material and a binder precursor, and fiberizing the binder precursor by applying shear stress to the mixture. The negative electrode comprises the negative electrode active material and a fibrous binder derived from the binder precursor, and the negative electrode active material has an ID/IG value of about 0.18 or more and less than about 0.7 as a result of Raman spectroscopy analysis. The negative electrode active material may be carbon-based. The negative electrode active material may have an XRD peak corresponding to the (002) plane at about 26.5°±0.5° according to XRD analysis results. An XRD peak corresponding to the (002) plane of the negative electrode active material may have a full width at half maximum (FWHM) of about 0.3 or more and less than about 0.395 according to XRD analysis results. The binder precursor may be in a particle form. The fibrous binder may comprise polytetrafluoroethylene (PTFE). The mixture may not comprise a solvent. The negative electrode may comprise about 50% by weight to about 99.9% by weight of the negative electrode active material and about 0.1% by weight to about 50% by weight of the fibrous binder.

In some embodiments, a negative electrode for a lithium secondary battery comprises a negative electrode active material, a fibrous binder, and a conductive material, where the negative electrode active material has an ID/IG value of about 0.18 or more and less than about 0.7 as a result of Raman spectroscopy analysis. The negative electrode active material may be a carbon-based material. The conductive material may comprise at least one selected from the group consisting of carbon black, conductive graphite, ethylene black, graphene, carbon nanotubes, and carbon nanofiber. The fibrous binder may comprise polytetrafluoroethylene (PTFE) and be fiberized by applying shear stress to a mixture of the negative electrode active material and a binder precursor. The negative electrode may comprise about 50% by weight to about 99.9% by weight of the negative electrode active material and about 0.1% by weight to about 50% by weight of the fibrous binder.

A lithium secondary battery may comprise the negative electrode described above.

The effects of the present disclosure are not limited to the effects mentioned above. The effects of the present disclosure should be understood to include all effects that can be inferred from the following description.

As discussed, the method and system suitably include use of a controller or processer.

### BRIEF DESCRIPTION OF THE DRAWINGS

FIG. 1 shows a lithium secondary battery according to the present disclosure;

FIG. 2 shows the internal structure of a negative electrode according to the present disclosure;

FIG. 3 shows capacity vs. voltage of a lithium secondary battery according to Examples 1 to 5 and Comparative Examples 1 to 3;

FIG. 4 shows the results of X-ray diffraction analysis of the negative electrode active materials of Examples 1 to 5 and Comparative Examples 1 to 4; and

FIG. 5 shows initial coulombic efficiency (ICE) of a lithium secondary battery according to Examples 1 to 5 and Comparative Examples 1 to 3.

### DETAILED DESCRIPTION OF EMBODIMENTS

The above objectives, other objectives, features, and advantages of the present disclosure will be easily understood through the following preferred embodiments related to the attached drawings. However, the present disclosure is not limited to the embodiments described herein and may be embodied in other forms. Rather, the embodiments introduced herein are provided so that the disclosed content will be thorough and complete and so that the spirit of the present disclosure can be sufficiently conveyed to those skilled in the art.

While describing each drawing, similar reference numerals are used for similar components. In the attached drawings, the dimensions of the structures are enlarged from the actual size for clarity of the present disclosure.

In this specification, terms such as “comprise” or “have” are intended to designate the presence of features, numbers, steps, operations, components, or parts, or combinations thereof described in the specification, but are not intended to indicate the presence of one or more other features. It should be understood that this does not exclude in advance the possibility of the existence or addition of elements, numbers, steps, operations, components, or parts, or combinations thereof. Additionally, when a part of a layer, membrane, region, and plate is said to be “on” another part, this includes not only being “directly above” the other part but also cases where there is another part in between. Conversely, when a part of a layer, membrane, region, and plate is said to be “underneath” another part, this includes not only being “immediately below” the other part but also cases where there is another part in between.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or expressions used herein expressing quantities of components, reaction conditions, polymer compositions, and formulations are intended to represent, among other things, how such numbers inherently occur in obtaining such values. Since they are approximations reflecting the various uncertainties of measurement, they should be understood in all cases as being qualified by the term “approximately”. Additionally, where a numerical range is disclosed herein, such a range is continuous and, unless otherwise indicated, includes all values from the minimum to the maximum of such a range inclusively. Furthermore, when such a range refers to an integer, all integers from the minimum value up to and including the maximum value are included, unless otherwise indicated.

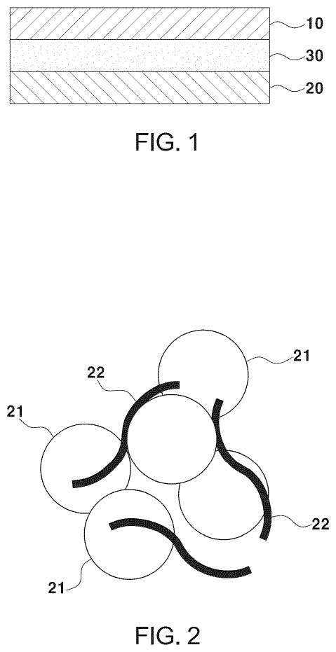

FIG. 1 shows a lithium secondary battery according to the present disclosure. The lithium secondary battery may include a positive electrode, a negative electrode, and a separator located between the positive electrode and the negative electrode.

The positive electrode may include positive electrode active materials, conductive materials, and positive electrode binders.

The positive electrode active materials may include a lithium transition metal oxide that absorbs and releases lithium. For example, the positive electrode active materials may include rock salt layer-type active materials (such as LiCoO₂, LiMnO₂, LiNiO₂, LiVO₂, and Li₁₊xNi_{1/3}Co_{1/3}Mn_{1/3}O₂), spinel-type active materials (such as LiMn₂O₄ and Li(Ni_{0.5}Mn_{1.5})O₄), inverse spinel type active materials (such as LiNiVO₄ and LiCoVO₄), olivine type active materials (such as LiFePO₄, LiMnPO₄, LiCoPO₄, LiNiPO₄), silicon-containing active materials (such as Li₂FeSiO₄ and Li₂MnSiO₄), rock salt layer-type active materials in which part of the transition metals is replaced with different metals (such as LiNi_{0.8}Co_{(0.2-x)}AlxO₂ (0<x<0.2)), spinel-type active materials in which part of the transition metals are replaced with different metals (such as Li₁₊ₓMn_{2-x-y}M_{y}O₄ (M is at least one of Al, Mg, Co, Fe, Ni, and Zn, and 0<x+y<2)), lithium titanate (such as Li₄Ti₅O₁₂), etc.

The conductive materials may include carbon black, conductive graphite, ethylene black, graphene, carbon nanotubes, carbon nanofibers, vapor-grown carbon fibers, etc.

The positive electrode binders may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), etc. The positive electrode binders may exist in a particle form or a linear form within the positive electrode.

Based on the total weight of the positive electrode, the positive electrode may include 70% by weight to 90% by weight of the positive electrode active materials, 1% by weight to 20% by weight of the conductive materials, and 1% by weight to 20% by weight of the positive electrode binders. Yet, the content of each component can be appropriately adjusted considering the capacity and efficiency of the desired lithium secondary battery.

The thickness of the positive electrode is not particularly limited but may be in a range of 1 μm to 100 μm. The thickness of the positive electrode may mean the average value when the measurement object is measured out of 5 points. Additionally, the thickness of the positive electrode may refer to the thickness of the lithium secondary battery when discharging.

FIG. 2 shows the internal structure of the negative electrode according to the present disclosure. The negative electrode may include negative electrode active materials and fibrous binders. Within the positive electrode, the negative electrode active materials 21 may be adhered to the fibrous binders.

When an electrode is manufactured by a wet method, binders dissolved in a solvent precipitate during the solvent removal process and cover the surface of solid particles such as the active materials. As a result, the precipitated binders block contact between solid particles and block a conduction path of lithium ions and an electronic conduction path within the electrode, causing problems such as short circuits and performance degradation of the battery.

The present disclosure relates to a negative electrode containing fibrous binders. The fibrous binders adhere to the negative electrode active materials, but since the area covering their surfaces is very small, problems with electrodes manufactured by a wet method do not occur.

The negative electrode active materials may include carbon-based active materials. For example, the negative electrode active materials may include graphite such as mesocarbon microbeads and highly oriented graphite; amorphous carbon such as hard carbon and soft carbon; etc.

The fibrous binders may include polytetrafluoroethylene (PTFE).

The polytetrafluoroethylene (PTFE) is a polymer in which all hydrogen elements of polyethylene (PE) are replaced with fluorine elements. Although polytetrafluoroethylene (PTFE) is a polymer with an aliphatic main chain, polytetrafluoroethylene (PTFE) has excellent thermal and electrical stability and is widely applied in the field of electronic materials. Since polytetrafluoroethylene (PTFE) has a cylindrical structure, polytetrafluoroethylene (PTFE) can be made into fiber even at low temperatures despite polytetrafluoroethylene (PTFE) having a high glass transition temperature (Tg).

The polytetrafluoroethylene (PTFE) may have a specific gravity of 2.185 or less. The lower limit of the specific gravity is not particularly limited and may be, for example, in a range of 2 or more. The specific gravity is a characteristic used to measure the relative molecular mass of polytetrafluoroethylene (PTFE). The specific gravity can be determined depending on the procedure described in ASTM D4895. To perform the test, specimens may be subjected to sintering and cooling cycles based on the appropriate sintering schedule as described in ASTM D4895. The specific gravity of polytetrafluoroethylene (PTFE) is inversely proportional to its molecular weight. When the specific gravity of polytetrafluoroethylene (PTFE) is in a range of 2.185 or less, the molecular weight of polytetrafluoroethylene (PTFE) is sufficiently high so that fiberizing can easily occur.

The basic fibrous binder may have a diameter in a range of 0.01 μm to 10 μm. The diameter refers to the diameter of the fibrous binders' cross section. The cross section refers to a section of the fibrous binders shown when the fibrous binders are cut in a perpendicular direction to the fibrous binders' longitudinal direction. When the diameter is in a range of less than 0.01 μm, the mechanical properties of the negative electrode may not be sufficient. When the diameter exceeds 10 μm, the electronic conductivity of the negative electrode may decrease.

It is known that polytetrafluoroethylene (PTFE) is decomposed into LiF when PTFE meets lithium ions (Li⁺) at a voltage of about 0.5V (vs Li/Li⁺). The present disclosure mitigates the decomposition reaction of polytetrafluoroethylene (PTFE) by taking materials with a low degree of graphitization and at the same time with the maintenance of crystallinity as negative electrode active materials.

The negative electrode active materials may have an ID/IG value of 0.18 or more and less than 0.7 as a result of Raman spectroscopy analysis. The ID/IG value is a measure of relative crystallinity. The ID/IG value can be measured as the ratio of the intensity value (ID) of the peak in the absorption region of from 1,350 cm⁻¹ to 1,380 cm⁻¹ to the intensity value (IG) of the peak in the absorption region of from 1,580 cm⁻¹ to 1,600 cm⁻¹ in the result of Raman spectroscopy analysis.

According to X-ray diffraction (XRD) analysis results, the negative electrode active materials may have an XRD peak corresponding to (002) plane at 26.5°±0.5° and have an XRD peak corresponding to (002) plane of the full width at half maximum (FWHM) of 0.3 or more and less than 0.395.

When the ID/IG value of the negative electrode active materials and the XRD peak corresponding to (002) plane of the full width at half maximum are within the range, the decomposition reaction of polytetrafluoroethylene (PTFE) can be alleviated.

Based on the total weight of the negative electrode, the negative electrode may include 50% by weight to 99.9% by weight of the negative electrode active materials and 0.1% by weight to 50% by weight of the fibrous binders. When the content of the fibrous binders is in a range of less than 0.1% by weight, the mechanical properties of the negative electrode may deteriorate. When the content of the fibrous binders exceeds 50% by weight, the negative electrode active materials is relatively small and the performance of the lithium secondary battery may deteriorate.

The thickness of the positive electrode Is not particularly limited but may be in a range of 1 μm to 100 μm. The thickness of the positive electrode may mean the average value when the measurement object is measured out of 5 points. Additionally, the thickness of the positive electrode may refer to the thickness of the lithium secondary battery when discharging.

The separator can Isolate the positive electrode and the negative electrode and prevent electrical short-circuiting due to physical contact.

The separator may be made of a material such as polypropylene or polyethylene.

The thickness of the separator is not particularly limited but may be in a range of 1 μm to 100 μm.

The positive electrode, negative electrode, and separator may be born with electrolyte.

The electrolyte may include an electrolyte solution and a lithium salt. The electrolyte is a kind of organic solvent and is not limited as long as the electrolyte can be used in a lithium secondary battery. For example, the electrolyte may include ethylenecarbonate, dimethylcarbonate, diethylcarbonate, ethylmethylcarbonate, fluoroethylenecarbonate, 1,2-dimethoxyethane, 1,2-diethoxyethane, dimethyleneglycoldimethylether, trimethyleneglycoldimethylether, triethyleneglycoldimethylether, tetraethyleneglycoldimethylether, polyethyleneglycoldimethylether, succinonitrile, sulfolane, dimethylsulfone, ethylmethylsulfone, diethylsulfone, adiponitrile, 1,1,2,2-tetrafluoroethyl 2,2,3,3-tetrafluoropropyl ether, dimethylacetamide, etc. The lithium salt is not limited as long as lithium salt can be used in a lithium secondary battery and may include, for example, LiNO₃, LiPF₆, LiBF₆, LiClO₄, LiCF₃SO₃, LiBr, LiI, etc.

The method of manufacturing a negative electrode for a lithium secondary battery according to the present disclosure may include: preparing a mixture containing negative electrode active materials and binder precursors; and fiberizing the binder precursors by applying shear stress to the mixture.

As the negative electrode active materials have been described above, a detailed description thereof will be omitted hereinafter.

The binder precursors are precursors of the fibrous binders and may include polytetrafluoroethylene (PTFE) in a particle form.

Since the manufacturing method is dry, the mixture may not contain a solvent. In other words, since the method of manufacturing the negative electrode according to the present disclosure is a dry method that does not use a solvent, the binder lifting phenomenon that occurs in the wet method does not occur, and the method of the present disclosure can be advantageous for thickening the negative electrode.

The method of applying the shear stress Is not particularly limited. Shear stress can be applied using devices and methods commonly used in the technical field to which the present disclosure pertains.

Other forms of the present disclosure will be described in more detail through examples below. The following examples are merely examples to aid understanding of the present disclosure, and the scope of the present disclosure is not limited thereto.

### EXAMPLES 1 TO 5

As shown in Table 1, graphite with different ID/IG values from the Raman spectroscopy results, the different positions of the XRD peaks corresponding to (002) plane, and the XRD peaks corresponding to (002) plane of the different full widths at half maximum from X-ray diffraction (XRD) analysis results were used as the negative electrode active materials.

Polytetrafluoroethylene (PTFE) in a particle form was used as binder precursors.

Based on the total weight of the negative electrode, a mixture was prepared by mixing 97% by weight of the negative electrode active materials and 3% by weight of the binder precursors, and shear stress was applied to the mixture. The binder precursors were subjected to shear stress and became fibrous binders, thereby obtaining a result in the form of clay.

The result was subject to calendering to produce a sheet-shaped negative electrode.

A positive electrode containing the positive electrode active materials of nickel-cobalt-manganese oxide, conductive materials, and positive electrode binders was prepared. Afterward, a laminate was manufactured in which the positive electrode, separator, and negative electrode were laminated in that order. By bearing the laminate with electrolyte, a lithium secondary battery was obtained.

### COMPARATIVE EXAMPLES 1 TO 4

A lithium secondary battery was manufactured in the same manner as Example 1, except that the negative electrode active materials and graphite differed from those shown in Table 1 below.

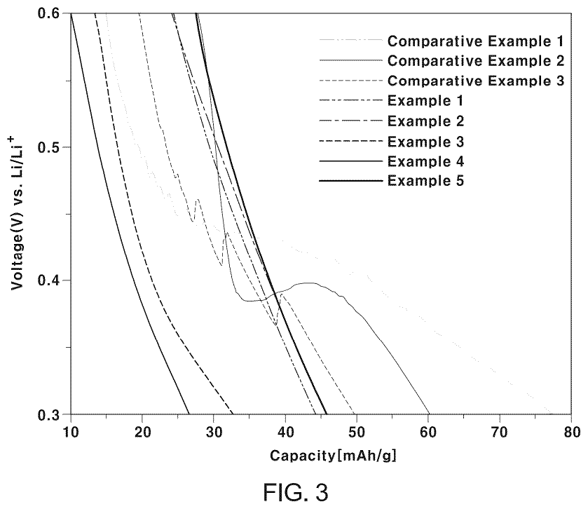

FIG. 3 shows capacity vs. voltage of a lithium secondary battery according to Examples 1 to 5 and Comparative Examples 1 to 3. The lithium secondary battery according to Comparative Example 4 had many defects in the graphite, making it impossible to store lithium, so a graph was not obtained. Referring to FIG. 3, Examples 1 to 4 show a smooth profile, whereas Comparative Examples 1 to 3 show a noisy profile. Through this, the decomposition reaction of the fibrous binders occurred in Comparative Examples 1 to 3.

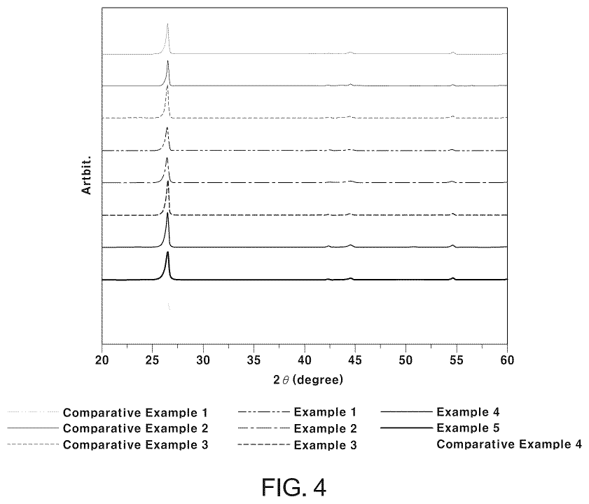

FIG. 4 shows the results of X-ray diffraction analysis of the negative electrode active materials of Examples 1 to 5 and Comparative Examples 1 to 4. The positions and full widths at half maximum of the XRD peaks corresponding to (002) plane for each negative electrode active material are shown in Table 1.

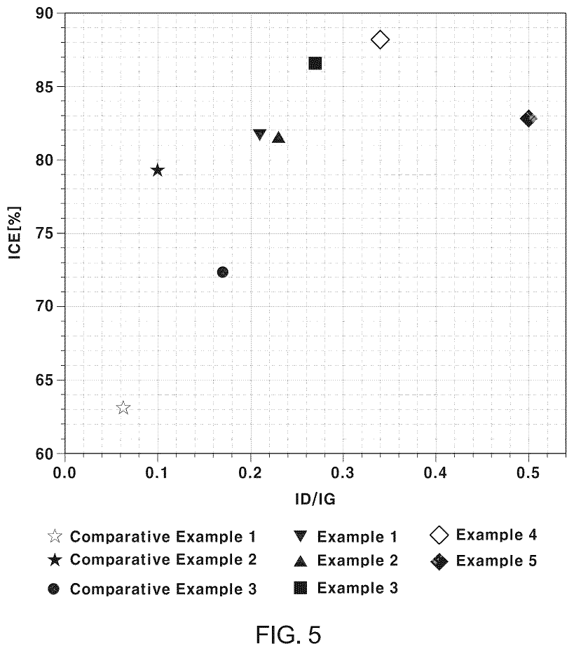

FIG. 5 is a result of the initial coulombic efficiency (ICE) of a lithium secondary battery according to Examples 1 to 5 and Comparative Examples 1 to 3. The results are shown in Table 1.

TABLE 1

| | | | | (002) | (002) | Binder |
|---|---|---|---|---|---|---|
| | First cycle | | | plane | plane | decom- |
| | Capacity | | | Peak | Peak | position |
| Division | [mAh/g] | ICE[%] | I_{D}/I_{G} | position | FWHM | profile |
| Comparative | 310.87 | 63.07 | 0.063 | 26.538 | 0.304 | ◯ |
| Example 1 | | | | | | |
| Comparative | 342.66 | 79.30 | 0.10 | 26.544 | 0.251 | ◯ |
| Example 2 | | | | | | |
| Comparative | 302.72 | 72.35 | 0.17 | 26.524 | 0.306 | ◯ |
| Example 3 | | | | | | |
| Example 1 | 310.74 | 81.80 | 0.21 | 26.51 | 0.374 | X |
| Example 2 | 307.98 | 81.46 | 0.23 | 26.509 | 0.367 | X |
| Example 3 | 317.58 | 86.6 | 0.27 | 26.544 | 0.308 | X |
| Example 4 | 326.06 | 88.20 | 0.34 | 26.54 | 0.317 | X |
| Example 5 | 330.54 | 82.78 | 0.50 | 26.536 | 0.375 | X |
| Comparative | X | X | 0.70 | 26.526 | 0.395 | X |
| Example 4 | | | | | | |

Referring to Table 1, when using graphite that satisfies the ID/IG value presented in the present disclosure and the full width at half maximum of the peak corresponding to (002) plane, the decomposition reaction of the fibrous binders can be suppressed and the performance of the lithium secondary battery, such as capacity and initial coulombic efficiency, can be improved.

As described above, although the embodiments have been described with limited examples and drawings, various modifications and variations can be made by those skilled in the art from the above description. For example, even when the described techniques are performed in a different order than the described method, and/or the described components are combined or combined in a different form than the described method, or are replaced or substituted by other components or equivalents. Adequate results can be achieved. Therefore, other implementations, other embodiments, and equivalents to the claims also fall within the scope of the claims described below.

What is claimed is:

1. A negative electrode for a lithium secondary battery, the negative electrode comprising:
a negative electrode active material; and
a fibrous binder,
wherein the negative electrode active material has an ID/IG value of about 0.18 or more and less than about 0.7 as a result of Raman spectroscopy analysis.

2. The negative electrode of claim 1, wherein the negative electrode active material comprises a carbon-based active material.

3. The negative electrode of claim 1, wherein the negative electrode active material has an XRD peak corresponding to (002) plane at about 26.5°±0.5° according to X-ray diffraction (XRD) analysis results.

4. The negative electrode of claim 1, an XRD peak corresponding to (002) plane of the negative electrode active material has a full width at half maximum (FWHM) of about 0.3 or more and less than about 0.395 according to X-ray diffraction (XRD) analysis results.

5. The negative electrode of claim 1, wherein the fibrous binder comprises polytetrafluoroethylene (PTFE).

6. The negative electrode of claim 1, the negative electrode comprises about 50% by weight to about 99.9% by weight of the negative electrode active material; and
about 0.1% by weight to about 50% by weight of the fibrous binder.

7. A method of manufacturing a negative electrode for a lithium secondary battery, the method comprising:
preparing a mixture comprising a negative electrode active material and a binder precursor; and
fiberizing the binder precursor by applying shear stress to the mixture,
wherein the negative electrode comprises the negative electrode active material and a fibrous binder derived from the binder precursor, and
wherein the negative electrode active material has an ID/IG value of about 0.18 or more and less than about 0.7 as a result of Raman spectroscopy analysis.

8. The method of claim 7, wherein the negative electrode active material comprises a carbon-based active material.

9. The method of claim 7, the negative electrode active material has an XRD peak corresponding to (002) plane at about 26.5°±0.5° according to X-ray diffraction (XRD) analysis results.

10. The method of claim 7, an XRD peak corresponding to (002) plane of the negative electrode active material has a full width at half maximum (FWHM) of about 0.3 or more and less than about 0.395 according to X-ray diffraction (XRD) analysis results.

11. The method of claim 7, wherein the binder precursor is in a particle form.

12. The method of claim 7, wherein the fibrous binder comprises polytetrafluoroethylene (PTFE).

13. The method of claim 7, wherein the mixture does not comprise a solvent.

14. The method of claim 7, the negative electrode comprises about 50% by weight to about 99.9% by weight of the negative electrode active material; and
about 0.1% by weight to about 50% by weight of the fibrous binder.

15. A negative electrode for a lithium secondary battery, the negative electrode comprising:
a negative electrode active material;
a fibrous binder; and
a conductive material,
wherein the negative electrode active material has an ID/IG value of about 0.18 or more and less than about 0.7 as a result of Raman spectroscopy analysis.

16. The negative electrode of claim 15, wherein the negative electrode active material comprises a carbon-based active material.

17. The negative electrode of claim 15, wherein the conductive material comprises at least one selected from the group consisting of carbon black, conductive graphite, ethylene black, graphene, carbon nanotubes, and carbon nanofiber.

18. The negative electrode of claim 15, wherein the fibrous binder comprises polytetrafluoroethylene (PTFE) and is fiberized by applying shear stress to a mixture of the negative electrode active material and a binder precursor.

19. The negative electrode of claim 15, wherein the negative electrode comprises about 50% by weight to about 99.9% by weight of the negative electrode active material and about 0.1% by weight to about 50% by weight of the fibrous binder.

20. A lithium secondary battery comprising the negative electrode of claim 1.
